(19) United States
(12) Patent Application Publication
(10) Pub. No.: US 2025/0117680 A1
(43) Pub. Date: Apr. 10, 2025

(54) TENSOR NETWORK BASED EFFICIENT QUANTUM DATA LOADING OF IMAGES

(71) Applicants: IONQ, INC., College Park, MD (US); Hyundai Motor Company, Kia Corporation, Seoul (KR)

(72) Inventors: Jason John IACONIS, Boulder, CO (US); Soon Cheol Park, Suwon-si (KR); Hanlae Jo, Seoul (KR)

(21) Appl. No.: 18/904,512

(22) Filed: Oct. 2, 2024

Related U.S. Application Data
(60) Provisional application No. 63/542,418, filed on Oct. 4, 2023.

(51) Int. Cl. G06N 10/20; G06N 10/40

(52) U.S. Cl. CPC G06N 10/20; G06N 10/40

(57) ABSTRACT

A method for data loading of an image in quantum machine learning includes encoding, in N qubits, an input (p_{xy}, x, y) of a grayscale image having Nₓ pixels on the x-axis and N_{y} pixels on the y-axis in a matrix product state using a plurality of tensors, wherein N=log₂(NₓN_{y}), 1≤x≤Nₓ, 1≤y≤N_{y}, 0<p_{xy}≤1, and x, y∈ [symbol] , and applying, on the N qubits, quantum circuits implementing the plurality of tensors, each of the quantum circuit comprising CNOT gates.

### CROSS-REFERENCE TO RELATED APPLICATIONS

This application claims priority to U.S. Provisional Application Ser. No. 63/542,418, filed Oct. 4, 2023, which is herein incorporated by reference in its entirety.

### BACKGROUND

### Field

The present disclosure generally relates to a method of performing computation in a quantum computing system that includes trapped ions, and more specifically, to a method of efficiently loading data that can be used in a quantum machine learning.

### Description of the Related Art

Quantum machine learning is emerging as a promising avenue for the application of near-term quantum computers. Recent work has shown that quantum algorithms offer advantages in expressivity and efficiency for certain machine learning tasks, and thus have the potential to outperform their classical counterparts in specific domains.

Images, as one of the most prevalent forms of data, have been extensively studied in classical machine learning. Quantum machine learning proposes new paradigms to accelerate image processing tasks. Experimental demonstrations of image-based learning with quantum computers include the training of a quantum-enhanced generative adversarial network that generates images from the MNIST dataset using 8 trapped-ion qubits, a quantum nearest centroid algorithm on the MNIST dataset on up to 8 trapped-ion qubits, and classification of medical images on up to 6 superconducting qubits.

In any quantum algorithm that processes classical data, the step of representing that data as a quantum state is a crucial one. Efficient data loading is imperative for overall algorithmic performance, and in the context of quantum machine learning, it can affect whether and how much quantum advantage can be practically achieved. Near-term quantum machine learning is usually formulated as a parametrized quantum circuit that is optimized according to a given learning task. In this framework, each data point is uploaded to a quantum state one at a time before the parametrized quantum circuit acts on it. In the case of images, each data point by itself can have a large amount of information, proportional to the number of pixels in the image. This poses a problem for near-term quantum computers because their gate fidelity is limited, with two-qubit gate fidelities typically an order of magnitude less than single-qubit gate fidelities. Overall, the number of gates in a quantum data loading circuits proposed so far scales with the size of the data. The number of two-qubit gates in particular is typically proportional to the ‘density’ of the data storage, which can be defined as the ratio between the size of the classical data and the size of the Hilbert space.

Therefore, near-term quantum image processing algorithms often aim to represent data ‘sparsely’, i.e. the number of qubits required scales linearly in the number of pixels. Examples of this are the unary amplitude encoding in which the number of two-qubit gates and number of qubits is proportional to the data size, and product state encoding in which there may be no two-qubit gates involved in the encoding at all. However, since the number of qubits is also limited in near-term quantum computers, using these techniques means that images need to be compressed before loading using techniques like principal component analysis, variational auto-encoders, or simple spatial averaging over image patches. In this process, one may lose information that is critical to the learning task, especially since none of these techniques is particularly sensitive to image-specific features like the presence of edges, which may make it hard to do more complex image processing tasks such as object detection.

Ideally, therefore, there would exist an efficient method that can create a quantum state that ‘densely’ stores the image data, i.e. the size of the Hilbert space is proportional to the number of pixels, and does not require many additional qubits during the state preparation procedure. In this context, the most recent proposal has been the QPIXL framework in which the number of gates scales linearly in the number of pixels. The authors also propose a compression technique which involves setting small angles to 0 during the state preparation procedure and show that some images can be stored with high quality while significantly reducing the number of gates required. However, due to the linear dependence on number of pixels, this technique may still be out of bounds for near-term quantum computers because of the large size and detailed nature of images present in real-world use cases.

### SUMMARY

Embodiments of the present disclosure provide a method for data loading of an image in quantum machine learning. The method includes encoding, in N qubits, an input (p_{xy}, x, y) of a grayscale image having Nₓ pixels on the x-axis and N_{y} pixels on the y-axis in a matrix product state using a plurality of tensors, wherein N=log₂(NₓN_{y}), 1≤x≤Nₓ, 1≤y≤N_{y}, 0<p_{xy}≤1, and x, y∈ [symbol] , and applying, on the N qubits, quantum circuits implementing the plurality of tensors, each of the quantum circuit comprising CNOT gates.

Embodiments of the present disclosure also provide a system for data loading of an image in quantum machine learning. The system includes a quantum processor comprising N qubits, each of the N qubits comprising a trapped ion having two hyperfine states, and a system controller configured to apply quantum circuits implementing a plurality of tensors to the N qubits in the quantum processor, by controlling control one or more lasers configured to emit a laser beam to the N qubits in the quantum processor, wherein an input (p_{xy}, x, y) of a grayscale image having Nₓ pixels on the x-axis and N_{y} pixels on the y-axis is encoded in the N qubits in a matrix product state using the plurality of tensors, and N=log₂(NₓN_{y}), 1≤x≤Nₓ, 1≤y≤N_{y}, 0<p_{xy}≤1, and x, y∈ [symbol] .

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of an ion trap quantum computing system according to one embodiment.

FIG. 2A depicts a schematic energy diagram of each ion in an ion chain according to one embodiment.

FIG. 2B depicts a schematic motional sideband spectrum of an ion in an ion chain according to one embodiment.

FIG. 3A depicts a 2-leg ladder tensor network that can encode pixel locations of a 2D grayscale image.

FIG. 3B depicts quantum circuit representation of an MPS for a bond dimension of 2.

FIG. 3C depicts approximate quantum circuit representation of an MPS for a bond dimension χ>2.

FIG. 4A depicts infidelity of the tensor network approximation to the amplitude encoded image as a function of the bond dimension χ for copies of the same image at different resolutions of dimension L×L.

FIG. 4B depicts an overall infidelity as a function of the image resolution L.

FIG. 4C depicts infidelity of the quantum circuit reconstruction of the large χ state as a function of circuit depth.

FIG. 4D depicts infidelity as a function of image dimension.

FIG. 5 depicts an exact image (far left) and MPS reconstructed images of a stop sign for resolutions L=32 and L=256, using the iterative circuit construction at depths (Left to Right) D=5,10,15 and 20 on an ideal simulator.

FIG. 6A depicts infidelity between the exact image and the MPS circuit approximation using two different circuit construction methods.

FIG. 6B depicts reconstruction of the quantum state generated at different circuit depths on an ideal simulator.

FIG. 7 depicts reconstruction of images of road scenes and a simple image.

To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

Image-based data is a popular arena for testing quantum machine learning algorithms. A crucial factor in realizing quantum advantage for these applications is the ability to efficiently represent images as quantum states. The embodiments described herein provide a novel method for creating quantum states that approximately encode images as amplitudes, based on recently proposed techniques that convert matrix product states to quantum circuits. The numbers of gates and qubits in the method according to the embodiments described herein scale logarithmically in the number of pixels given a desired accuracy, which make it suitable for near term quantum computers. Finally, experimentally demonstration of the technique according to the embodiments described herein on 8 qubits of a trapped ion quantum computer for complex images of road scenes is shown to make this the first large instance of full amplitude encoding of an image in a quantum state.

To address the above issues, the embodiments described herein provide an approach for dense approximate amplitude encoding of images as quantum states using a number of gates and qubits that are logarithmic in the number of pixels. This technique is based on converting a matrix product state representation of an image into a quantum circuit. A related application of this technique has been used for loading probability distributions to quantum states in the art. It is noted that tensor network methods have found applications in a wide range of quantum information problems and quantum machine learning, but not been used in the context of loading classical data to quantum states in the art. The method described herein provides quantifiable control of the accuracy, which means that the fidelity of the encoded image can be systematically improved as quantum computers advance without changing the underlying encoding scheme.

### General Hardware Configurations

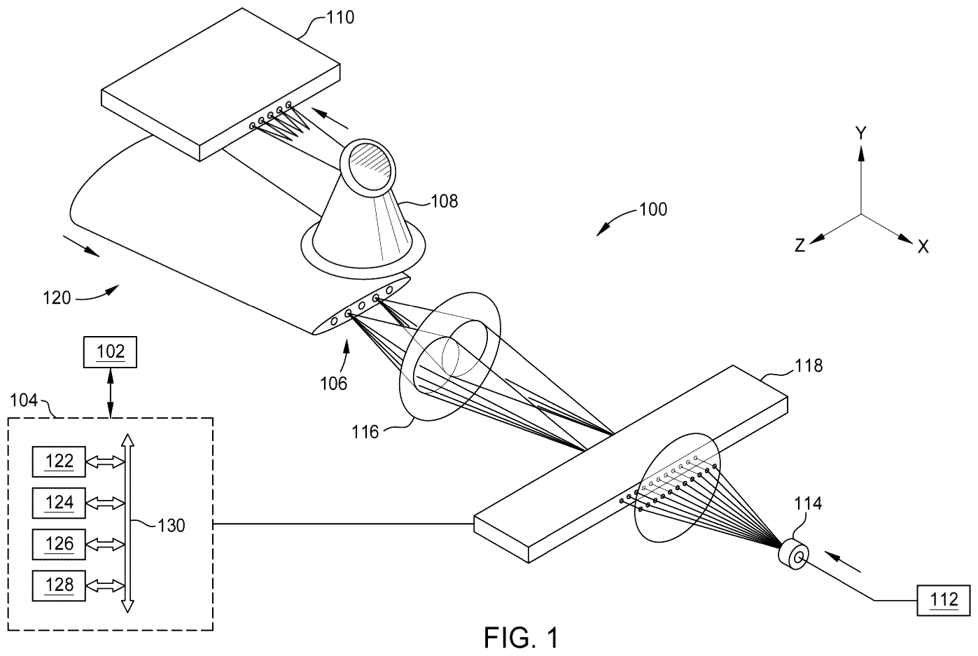

FIG. 1 is a schematic partial view of an ion trap quantum computing system, or system 100, according to one embodiment. The system 100 includes a classical (digital) computer 102, a system controller 104 and a quantum processor that is an ion chain 106 having trapped ions (i.e., five shown) that extend along the Z-axis. The classical computer 102 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. Software instructions, algorithms and data can be coded and stored within the non-volatile memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 for measurement of individual ions. Non-copropagating Raman laser beams from a laser 112, which are provided along the X-axis, perform operations on the ions. A diffractive beam splitter 114 creates an array of static Raman beams 116 that are individually switched using a multi-channel acousto-optic modulator (AOM) 118 and is configured to selectively act on individual ions. A global Raman laser beam 120 illuminates all ions at once. The system controller (also referred to as a “RF controller”) 104 controls the AOM 118 and thus controls laser pulses to be applied to trapped ions in the ion chain 106. The system controller 104 includes a central processing unit (CPU) 122, a read-only memory (ROM) 124, a random access memory (RAM) 126, a storage unit 128, and the like. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by processor in order to perform various functionalities associated with receiving and analyzing data and controlling any and all aspects of the methods and hardware used to create the ion trap quantum computer system 100 discussed herein.

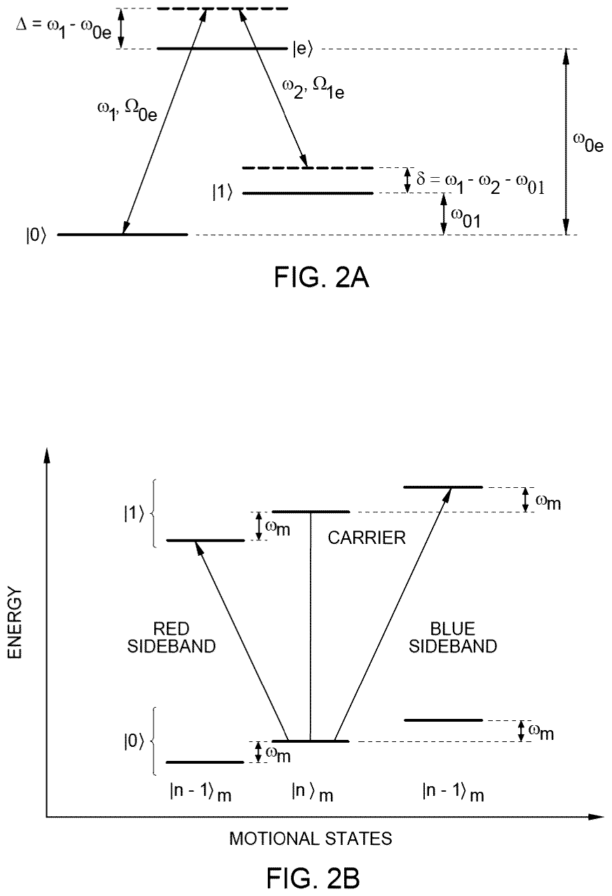

FIG. 2A depicts a schematic energy diagram of each ion in the ion chain 106 according to one embodiment. In one example, each ion may be a positive Ytterbium ion, ¹⁷¹Yb⁺, which has the ²S_{1/2} hyperfine states (i.e., two electronic states) with an energy split corresponding to a frequency difference (referred to as a “carrier frequency”) of ω₀₁/2π=12.6 GHz. A qubit is formed with the two hyperfine states, used to represent computational basis |0 [symbol] and |1 [symbol] (|i [symbol] (i∈Z) [symbol] , where the hyperfine ground state (i.e., the lower energy state of the ²S_{1/2} hyperfine states) is chosen to represent |0 [symbol] . Hereinafter, the terms “hyperfine states,” “internal hyperfine states,” and “qubit states” may be interchangeably used to represent computational basis states |0 [symbol] and |1 [symbol] (|i [symbol] (i∈Z) [symbol] . Each ion may be cooled (i.e., kinetic energy of the ion may be reduced) to near the motional ground state |0 [symbol] ₘ for any motional mode m with no phonon excitation (i.e., nₚₕ=0k) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₘ with the subscript m denotes the motional ground state for a motional mode m of the ion chain 106.

An individual qubit state of each trapped ion may be manipulated by, for example, a mode-locked laser at 355 nanometers (nm) via the excited ²P_{1/2} level (denoted as |e [symbol] [symbol] . As shown in FIG. 2A, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁-ω₀ₑ with respect to the transition frequency ω₀ₑ between |0 [symbol] and |e [symbol] , as illustrated in FIG. 2A. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than a two-photon transition detuning frequency (also referred to simply as “detuning frequency”) δ=ω₁-ω₂-ω₀₁ (hereinafter denoted as ±μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁-ω₂-ω₀₁ may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be⁺, Ca⁺, Sr⁺, Mg+, and Ba⁺) or transition metal ions (Zn⁺, Hg⁺, Cd⁺).

FIG. 2B depicts a schematic motional sideband spectrum of each ion in the ion chain 106 in a motional mode |nₚₕ [symbol] _{M} having frequency ωₘ according to one embodiment. As illustrated in FIG. 2B, when the detuning frequency of the composite pulse is zero (i.e., a frequency difference between the first and second laser beams is tuned to the carrier frequency, δ=ω₁-ω₂-ω₀₁=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=ω₁-ω₂-ω₀₁=μ>0, referred to as a blue sideband), Rabi flopping between combined qubit-motional states |0 [symbol] |nₚₕ [symbol] ₘ and |1 [symbol] |nₚₕ+1 [symbol] ₘ occurs (i.e., a transition from the m-th motional mode with n-phonon excitations denoted by |nₚₕ [symbol] ₘ to the m-th motional mode with (nₚₕ+1)-phonon excitations denoted by |nₚₕ+1 [symbol] ₘ occurs when the qubit state |0 [symbol] flips to |1 [symbol] ). When the detuning frequency of the composite pulse is negative (i.e., the frequency difference between the first and second laser beams is tuned lower than the carrier frequency by the frequency ωₘ of the motional mode |nₚₕ [symbol] ₘ, δ=ω₁-ω₂-ω₀₁=−μ<0, referred to as a red sideband), Rabi flopping between combined qubit-motional states |0 [symbol] |nₚₕ [symbol] ₘ and |1 [symbol] |nₚₕ−1 [symbol] ₘ occurs (i.e., a transition from the motional mode |nₚₕ [symbol] ₘ to the motional mode |nₚₕ−1 [symbol] ₘ with one less phonon excitations occurs when the qubit state |0 [symbol] flips to |1 [symbol] ). A π/2-pulse on the blue sideband applied to a qubit transforms the combined qubit-motional state |0 [symbol] |nₚₕ [symbol] ₘ into a superposition of |0 [symbol] |nₚₕ [symbol] ₘ and |1 [symbol] |nₚₕ+1 [symbol] ₘ. A π/2-pulse on the red sideband applied to a qubit transforms the combined qubit-motional |0 [symbol] |nₚₕ [symbol] ₘ into a superposition of |0 [symbol] |nₚₕ [symbol] ₘ and |1 [symbol] |nₚₕ−1 [symbol] ₘ. When the two-photon Rabi frequency Ω(t) is smaller as compared to the detuning frequency δ=ω₁-ω₂-ω₀₁=±μ, the blue sideband transition or the red sideband transition may be selectively driven. Thus, qubit states of a qubit can be entangled with a desired motional mode by applying the right type of pulse, such as a π/2-pulse, which can be subsequently entangled with another qubit, leading to an entanglement between the two qubits that is needed to perform an XX-gate operation in an ion trap quantum computer.

### Quantum Data Loading of Images

First, the amplitude encoding of images are defined and how it can be used in a quantum machine learning algorithm is described. Suppose a grayscale image with Nₓ pixels on the x-axis and N_{y} pixels on the y-axis is to be encoded. Let the image to be encoded be given by (p_{xy}, x, y) with 1≤x≤Nₓ and 1≤y≤N_{y} and 0≤p_{xy}≤1 and x, y∈ [symbol] . This image can be encoded using N=log₂(NₓN_{y}) qubits defined as

$$Ψ = \frac{1}{𝒩} {Σ}_{x = 1}^{{N}_{x}} {Σ}_{y = 1}^{{N}_{y}} \sqrt{{p}_{x y}} {e}^{i {ϕ}_{x y}} xy , \qquad ( 1 )$$

where x and y are computational basis states corresponding to binary representations of x and y respectively, and [symbol] =Σₓ₌₁^{N}^{ₓ}Σ_{y=1}^{N}^{_{y}} p_{xy}. ϕ_{xy} are arbitrary phases. For an image with multiple color channels, a state of this form can be used to encode each channel.

A quantum machine learning model maps an input (p_{xy}, x, y) to a value c using a parametrized operator Ĉ which can then be used for further classification. If the model uses a single copy of Ψ,

$$c = {Σ}_{{x}^{′} , x = 1}^{{N}_{x}} {Σ}_{{y}^{′} , y = 1}^{{N}_{y}} \sqrt{{p}_{{x}^{′} {y}^{′}} {p}_{x y}} {e}^{i ( {ϕ}_{x y} - {ϕ}_{{x}^{′} {y}^{′}} )} {C}_{{x}^{′} , {y}^{′} , x , y} , \qquad ( 2 )$$

where C_{x′,y′,x,y}=y′x′Ĉxy. Thus, the output of the model is quadratic in the pixel amplitudes \sqrt{p_{xy}}. If k copies of the state Ψ are used by the model, then the output is a polynomial of power 2k in the pixel intensities. Setting the total number of pixels, L²=NₓN_{y}, it can be seen that classically simulating this same model would thus involve a number of operations that scales as O(L^{4k}). Parametrized quantum circuits for machine learning have a number of gates that scale polynomially in the number of qubits, meaning that their execution time scales as O(log L)). With loading time linear in the number of pixels as in the QPIXL formalism, each execution of a quantum model would involve a number of operations that scales as O(L^{2k}), being limited by the loading time. The technique according to the embodiments described herein has loading time that is O(log(L)) for a given accuracy and this allows for the execution time of a quantum model to also be O(log(L)). Therefore, this loading technique allows potential quantum advantage from variational quantum models to clearly emerge, compared to previous loading methods where the execution time is dominated by the loading time.

The image loading technique according to the embodiments described herein is now explained by giving a brief introduction to matrix product states. A matrix product state (MPS) is a wave function of the form

$$Ψ = {Σ}_{\{ σ \}} [ {Π}_{i = 1}^{N} {M}_{{α}_{i - 1} {α}_{i}}^{[ i ] , {σ}_{i}} ] {σ}_{1} … {σ}_{N} \qquad ( 3 )$$

where the terms M_{α}_{_{i−1}}_{,α}_{ᵢ}^{[i],σ}^{ᵢ} are N different 3-index tensors, and the Einstein summation convention that repeated indices are summed over is used. Each tensor contains a “physical” index σᵢ∈[1, d], and “bond” indices αᵢ∈[1, χ]. Here d is the local dimension of the quantum state, so that d=2 for qubits. The maximum value of the bond indices αᵢ is known as a bond dimension χ, and controls the amount of entanglement which can be represented by the MPS. A given MPS representation of a quantum state can be compressed by performing successive singular value decompositions (SVD) on the individual tensors and truncating eigenvalues/eigenvectors of the individual tensors. For each matrix, the so called truncation error is given by the sum of the squares of the discarded singular values ϵ=Σᵢ₌ₘ₊₁²^{ⁱ}, λᵢ², and controls the fidelity of this compression method. For a state Ψ and allowed error ϵ, it can be approximately represented as a MPS if, for arbitrary N, there exists a fixed χ MPS, \tilde{Ψ} such that the Frobenius norm

$${‖ ψ - \tilde{ψ} ‖}^{2} \leq ϵ . \qquad ( 4 )$$

It has been shown that smooth differentiable functions which are encoded in the amplitude of a quantum state using a big-endian binary encoding scheme have low entanglement, due to the vanishing additional entanglement cost of adding extra qubits of decreasing significance. This property was exploited in the art to show that smooth 1D probability distributions can be efficiently loaded using MPS states, which leads to an efficient state preparation method for these distributions on a quantum computer. While originally developed as efficient representations of 1D quantum states, matrix product states have since found rich applications when applied to 2D and quasi-2D quantum systems.

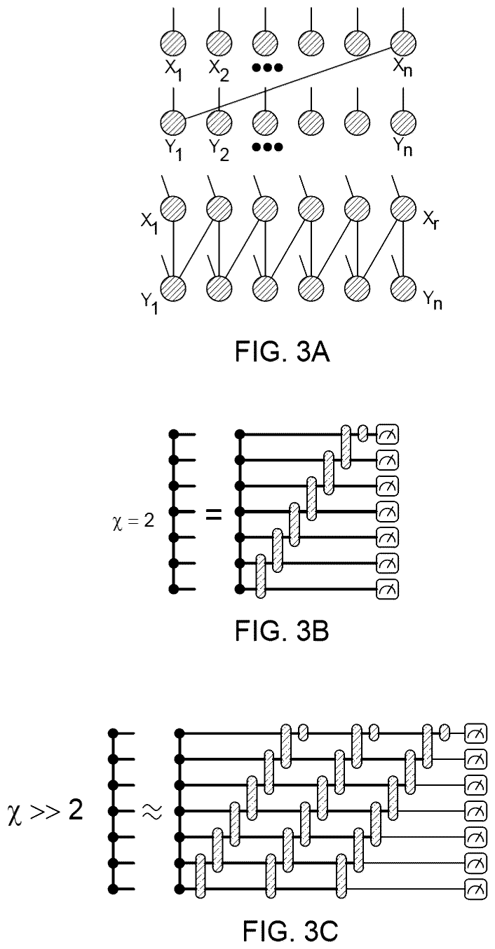

In the embodiments described herein, it is demonstrated how these techniques also allow for an efficient representation of amplitude encoded 2D images by tensor networks, and therefore dramatically improve the prospects of encoding 2D images in quantum states. The amplitude encoded 2D image can be viewed as a quantum system on a 2-leg ladder, with the most significant digit of the x and y coordinate of the pixel location represented by the rung of the ladder, as in FIG. 3A. A matrix product state (MPS) representation can connect this ladder via one of the two 1D paths shown. In the examples shown below, the 1D path in the upper figure is used. However, it has been found that both 1D paths give nearly identical results. In the embodiments described herein, Nₓ=N_{y}=L is used, but note that the construction is straightforwardly extended to the case Nₓ≠N_{y}.

The image loading procedure according to the embodiments described herein is now described. State preparation of an arbitrary quantum state on N qubits requires a circuit with [symbol] (2^{N}) CNOT gates. A grayscale image with L²(=Nₓ×N_{y}) pixels can be efficiently represented using an amplitude encoded quantum state with only N=2log₂(L)(=log₂(Nₓ×N_{y})) qubits, however, exactly performing the state preparation procedure would require L²(=Nₓ×N_{y}) quantum gates. Instead, consider that if the indices αᵢ₋₁ε[1, m], αᵢε[1, n] and σε[1, d], then M_{α}_{_{i−1}}_{,α}_{ᵢ}^{σ}^{ᵢ} is an m×n×d tensor which can be cast as an isometry from m dimensions to dn dimensions, with the property that

$${Σ}_{σ , {α}_{i}} {M}_{{α}_{i - 1} , {α}_{i}}^{{σ}_{i}} {M}_{{α}_{i - {1}^{′}} {α}_{i}}^{* {σ}_{i}} = {I}_{{α}_{i - 1 ,} {α}_{i - {1}^{′}}} . \qquad ( 5 )$$

Each of these isometries, M_{α}_{_{i−1}}_{,α}_{ᵢ}^{σ}^{ᵢ}, can be implemented in a quantum circuit as an operator which acts on log₂(dn) qubits when n≥m, which can be further decomposed in [symbol] (dmn) CNOT gates. When applied in series, as in the example for χ=2 shown in FIG. 3B, the quantum circuit implementing these isometries exactly prepares the matrix product state wave function. Therefore, a MPS with a bond dimension x consists of log₂(L)(=1/2log₂(NₓN_{y})=1/2N) isometries with m=n=χ and can therefore be exactly prepared with only [symbol] (log(L)dχ²)˜ [symbol] (Nχ²) CNOT gates. For small values of the bond dimension χ, this represents a large compression in the circuit required for quantum state preparation.

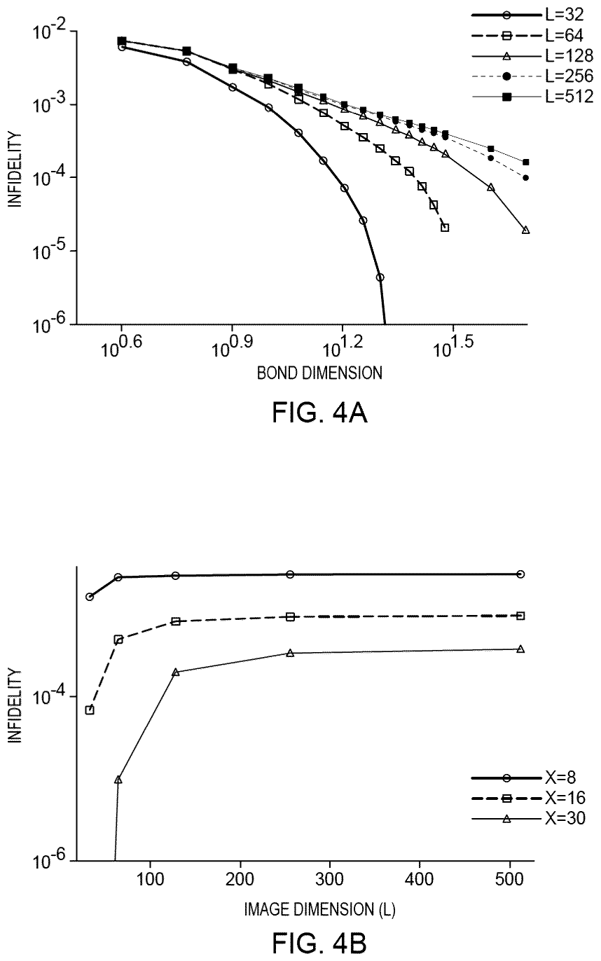

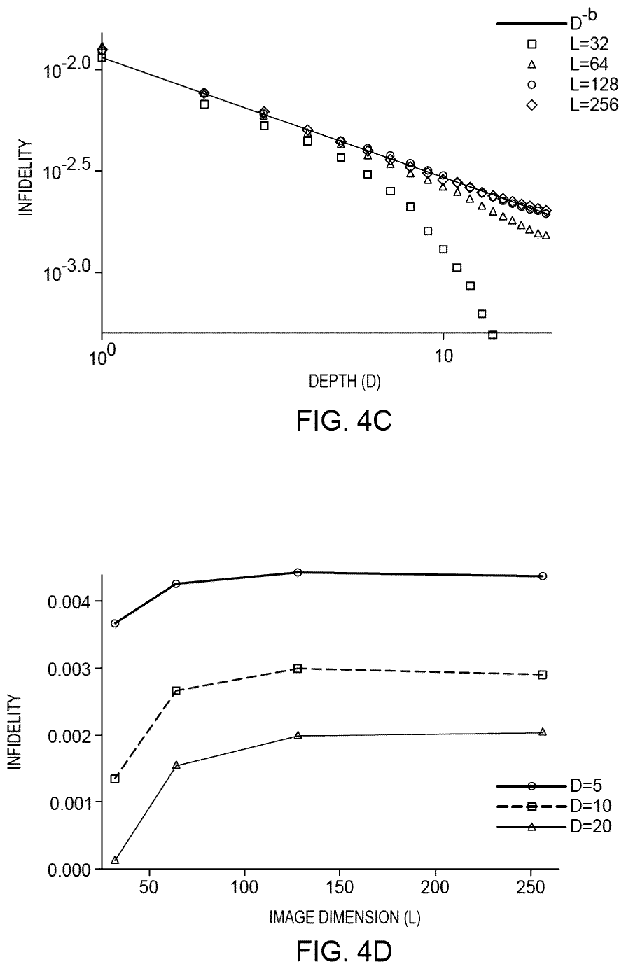

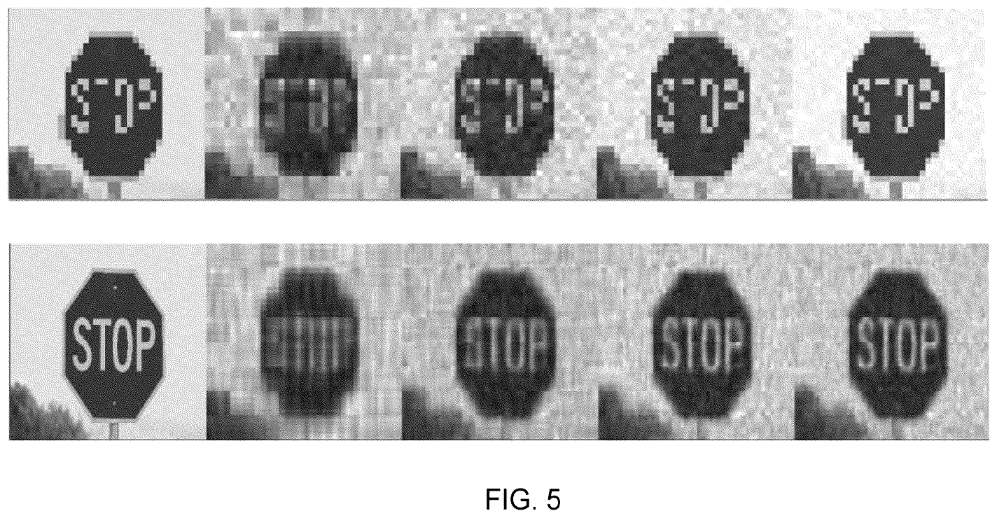

For images, it has been found that a constant bond dimension χ is sufficient to represent an image to a given fidelity | [symbol] Ψ|\tilde{Ψ} [symbol] |, independent of the image resolution. This is seen in FIG. 4B, where the infidelity I=1−| [symbol] Ψ|\tilde{Ψ} [symbol] | plateaus as a function of image size at fixed bond dimension χ. This implies that a circuit with a fixed depth and only [symbol] (log(L)χ²) CNOT gates can load arbitrarily high-resolution images.

FIG. 4A demonstrates the infidelity as a function of the truncated bond dimension χ, when applied to images of a stop sign shown in FIG. 5, which is down-scaled to a lower resolution of size L×L. At large L, and for χ<<L, it has been found that the infidelity obeys the scaling law

$$I = \frac{a}{{χ}^{b}} . \qquad ( 6 )$$

In this case, it has been found b=1.645(18), although it is expected that this exponent may depend on the specific properties of the image being encoded. Therefore, for high resolution images there is always a large compression which can be achieved using the MPS representation of the image, and the desired fidelity can always be increased by increasing the bond dimension χ. Note, also, that as χ→L, the infidelity deceases more rapidly with the bond dimension χ.

However, for near-term application, this MPS state preparation procedure still results in a large number of 2-qubit gates, which may render it impractical. For this reason, a number of approximation methods have been developed for directly constructing a high bond dimension MPS state using a small number of one and two qubit gates. A χ=2 MPS can be simply prepared with a single layer quantum circuit of the form shown in FIG. 3B, where each of the N two qubit unitaries applies a general O(4) rotation that can be implemented using at most 2 CNOT gates plus a potential SWAP operation. For higher bond-dimension MPS states, there exist several low-depth state preparation algorithms which approximate the χ>>2 MPS by repeatedly applying a series of single layer χ=2 circuits. The two main algorithms which have been proposed for this approximation are the iterative circuit construction and the gate-by-gate optimization method in the art. In the iterative circuit construction method, D layers of χ=2 MPS circuits are applied in series, with each layer i implementing the unitary circuit U^{[i]} such that

$${{U}^{[ 1 ]} 0 = Ψ \vert}_{χ = 2} \qquad ( 7 )$$

$${{U}^{[ i ]} 0 = ( {U}^{[ i - 1 ] †} … {U}^{[ 1 ] †} Ψ ) \vert}_{χ = 2} \qquad ( 8 )$$

$${U}_{tot} = {U}_{D} … {U}_{2} {U}_{1} \qquad ( 9 )$$

where Ψ|_{χ} represents the truncation of the wave function Ψ, to bond dimension χ. In this way, a MPS with high bond dimension χ can be approximately prepared using the circuit structure shown in FIG. 3C. The same circuit structure is used to represent the quantum state in the art, however it was shown that the individual unitaries can be optimized one at a time by sweeping through the quantum circuit and applying the optimization algorithm shown in the art. In this optimization scheme, one calculates the environment tensor in a circuit with M two-qubit unitary gates Uᵢ as

$${F}_{m} = {Tr}_{{\overline{U}}_{m}} [ {\prod }_{i = M}^{m + 1} {U}_{i} Ψ0 {\prod }_{j = 1}^{m - 1} {U}_{j}^{†} ] , \qquad ( 10 )$$

where Tr_{Ū}_{ₘ} is the trace over all qubit indices which don't interact with Uₘ and which can be evaluated in practice by contracting the quantum circuit with gate m removed with the exact MPS state Ψ. The optimization algorithm proceeds by performing the SVD Fₘ= [symbol] ^{†}, and replacing the unitary Uᵢ with the new unitary matrix [symbol] ^{†}. This sweeping gate-by-gate optimization algorithm can lead to a large improvement in the fidelity of the reconstructed state at the same circuit depth as the iterative algorithm. In the embodiments described herein, the improved version of this algorithm described is applied, where all D−1 layers of the MPS circuit are optimized using this gate-by-gate method, and a new layer numbered D is generated using Eqs 7-9. Once this new layer is added, all D layers are re-optimized using the algorithm to produce the final circuit.

This circuit approximation method is used to generate low-depth quantum circuits which approximately prepare the quantum states in Eq. 1. Throughout the optimization procedure, the bond dimension of the target MPS is limited to χ≤32. The results of this procedure as a function of circuit depth and image resolution are shown in FIG. 4C, for the sample stop sign image. Again, it has been found that the infidelity decreases as a power law with the circuit depth D, measured in terms of the number of MPS layers applied. It has been found that

$$I = \frac{a}{{D}^{b}} \qquad ( 11 )$$

with b=0.603 (7). As shown in FIG. 4D, it has been also found that the infidelity tends to a constant as L increases at fixed D.

FIG. 5 shows the reconstructed image which is generated by the quantum circuit at depths D=5-20. Again, it has been found an additional boost in performance when applied to images with the smallest resolution, so that for images of size 32×32, the reconstruction appears adequate at D=10 when 180 CNOT gates are applied and nearly ideal at depth 20, when 360 CNOT gates are applied. This is a compression of roughly 80-90% compared to a naive encoding method. IT has also been shown the reconstruction for images of dimension 256×256. Again, a good reconstruction between depths 10-20 can be seen, where 260-520 CNOT gates are applied to load an image with 65536 pixels, a compression of >99.5%.

FIG. 5 indicates that the effect of increasing the circuit depth is to increase the sharpness of the edges. A similar effect is expected when the bond dimension x is increased. This indicates that the use of larger depth circuits for encoding will increase the accuracy of visual pattern recognition and detection of small objects.

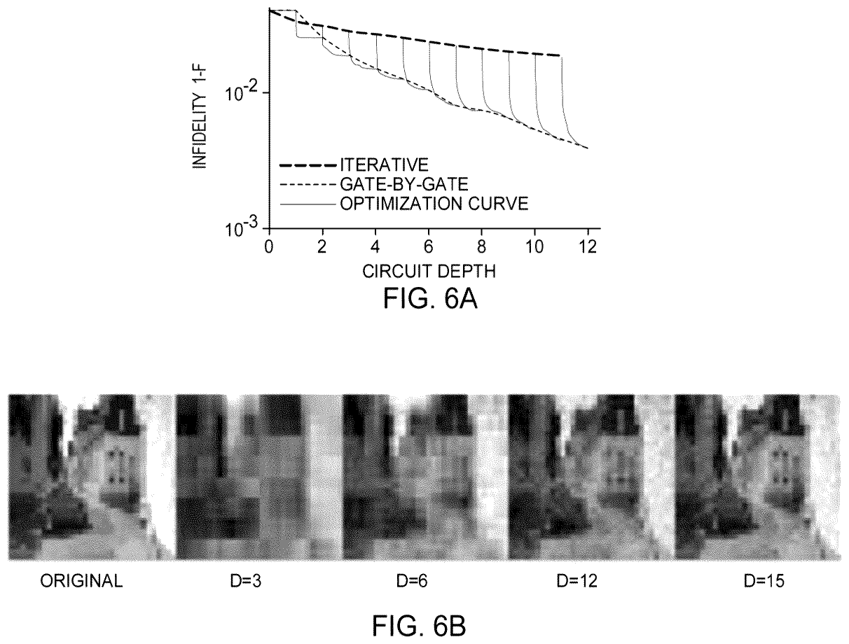

In FIGS. 6A and 6B, the state preparation procedure has been performed on a more complex road scene image of size 32×32. Even using this complex image, it can be seen that the state preparation method according to the embodiments described herein gives a good reconstruction for depths D>12. The iterative and gate-by-gate training procedures, where each gate-by-gate optimization is run for 200 sweeps, are compared. The starting point for the gate-by-gate optimization at each depth is the iterative circuit construction. It can be seen that the gate-by-gate optimization gives a large improvement over the iterative circuit construction and appears to give superior scaling of Infidelity with circuit depth.

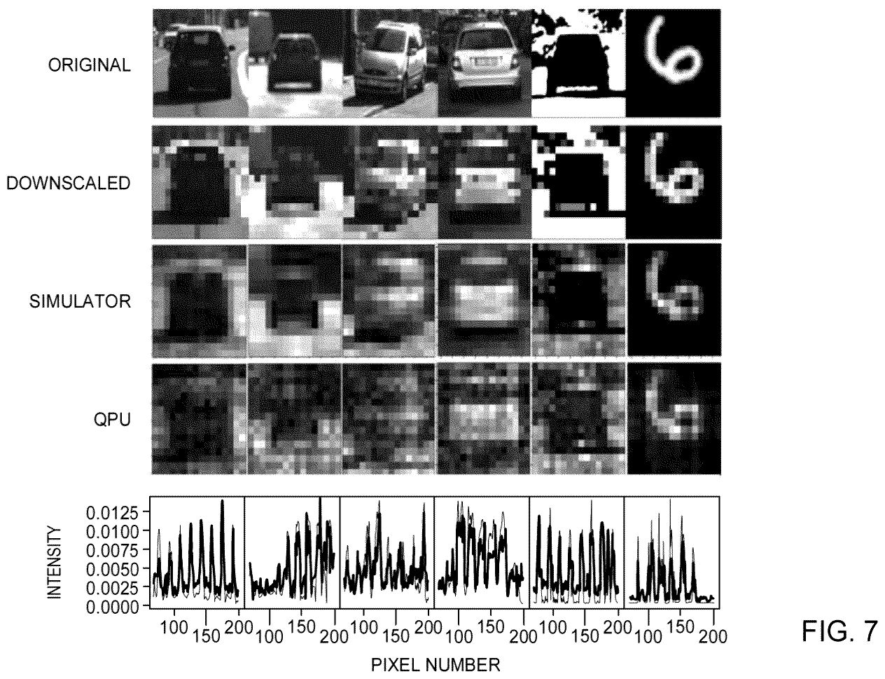

Finally, this state preparation procedure has been experimentally implemented on a trapped-ion quantum processing unit (QPU). As shown in FIG. 7, four images of road scenes containing a vehicle and one simpler image from the MNIST dataset are chosen. Each original image is first down-scaled to dimension 16×16. Each amplitude encoded state has been prepared using a depth 3 MPS circuit with the gate-by-gate optimization method. These are then loaded onto 8 qubits of the QPU one at a time. After loading, the qubits are measured in the computational basis to reconstruct the loaded image. The results of the reconstruction are shown in FIG. 7 and compared to the original image as well as the results from an ideal simulator. Here the top row shows the original images and the second row the downscaled ones. The third row is the output from running the circuits on an ideal simulator. The fourth row is the output from the QPU. Note that in addition to noise due to gate execution and measurement, the reconstruction is also limited by statistical shot noise due to the limited number of shots that were taken.

It can be seen that the state preparation method according to the embodiments described herein is able to maintain the large scale structure of the complex road scene images despite the noise on the hardware. To see this more clearly, in the bottom row, curves that show the intensity as a function of pixel number are plotted, effectively ‘flattening’ the image. It can be seen that the QPU output closely follows the trend of the simulator output despite the noisy execution. The results are even more visually impressive when applied to the simpler MNIST image shown in the far right column of FIG. 7. This represents the first example of full amplitude encoding of large uncompressed images into quantum states. In all cases, it is believed that enough detail in the images is maintained to be directly relevant for current quantum image processing algorithms.

The embodiments described herein provide a technique for encoding images into quantum states that makes efficient use of the qubits as well as scales logarithmically in the number of pixels. It has been shown through numerical testing that the technique has favorable scaling properties in terms of the circuits depths required to reach desired fidelities. Being suitable for near-term quantum computers, the technique allows for the design and testing of quantum learning models that are based on amplitudes of computational basis states. Since the data loading time is logarithmic in the number of pixels, it is no longer the leading order factor in the execution time of a typical quantum learning algorithm, and it allows for the realization of quantum advantage based on parameterized quantum circuits with the appropriate expressivity.

It is expected that future work will improve the optimization procedures that are involved in creating the circuit. The exploration of higher-dimensional tensor network methods is also expected to make improvements to loading image fidelity while keeping the circuit depth the same. The method according to the embodiments described herein will likely also generalize to other data types, such as video or three-dimensional data. Finally, it is anticipated that an end-to-end demonstration of a quantum machine learning algorithm that utilizes this data loading scheme will lead to a future milestone in the field of quantum machine learning.

1. A method for data loading of an image in quantum machine learning, comprising:
encoding, in N qubits, an input (p_{xy}, x, y) of a grayscale image having Nₓ pixels on the x-axis and N_{y} pixels on the y-axis in a matrix product state using a plurality of tensors, wherein N=log₂(NₓN_{y}), 1≤x≤Nₓ, 1≤y≤N_{y}, 0≤p_{xy}≤1, and x, y∈ [symbol] ; and
applying, on the N qubits, quantum circuits implementing the plurality of tensors, each of the quantum circuit comprising CNOT gates.

2. The method of claim 1, wherein each of the N qubits comprises a trapped ion having two hyperfine states.

3. The method of claim 1, wherein applying a quantum circuit comprising CNOT gates between two of the N qubits comprises providing laser beams to the two of the N qubits.

4. The method of claim 1, wherein the number of the plurality of tensors is N and the quantum circuits implementing the plurality of tensors comprise [symbol] (Nχ²) CNOT gates, with χ being a bond dimension that controls amount of entanglement which can be represented by the matrix product state.

5. The method of claim 1, further comprising:
compressing the matrix product state by performing successive singular value decompositions (SVD) on the plurality of tensors and truncating eigenvalues and eigenvectors of the plurality of tensors.

6. A system for data loading of an image in quantum machine learning, comprising:
a quantum processor comprising N qubits, each of the N qubits comprising a trapped ion having two hyperfine states; and
a system controller configured to apply quantum circuits implementing a plurality of tensors to the N qubits in the quantum processor, by controlling control one or more lasers configured to emit a laser beam to the N qubits in the quantum processor, wherein:
an input (p_{xy}, x, y) of a grayscale image having Nₓ pixels on the x-axis and N_{y} pixels on the y-axis is encoded in the N qubits in a matrix product state using the plurality of tensors, and
N=log₂(NₓN_{y}), 1≤x≤Nₓ, 1≤y≤N_{y}, 0≤p_{xy}≤1, and x, y∈ [symbol] .

7. The system of claim 6, wherein each of the trapped ions is ¹⁷¹Yb⁺ having the ²S_{1/2} hyperfine states.

8. The system of claim 6, wherein each of the trapped ions is one selected from Be⁺, Ca⁺, Sr⁺, Mg+, Ba⁺, Zn⁺, Hg⁺, Cd⁺.

9. The system of claim 6, wherein each of the quantum circuit comprises CNOT gates.

10. The system of claim 6, wherein the number of the plurality of tensors is N and the quantum circuits implementing the plurality of tensors comprise [symbol] (Nχ²) CNOT gates, with χ being a bond dimension that controls amount of entanglement which can be represented by the matrix product state.
